(19) United States
(12) Patent Application Publication
(10) Pub. No.: US 2008/0113440 A1
(43) Pub. Date: May 15, 2008

(54) Method and Apparatus for Tissue Sample Processing

(75) Inventors: Phillip Clyde Roberts Gurney, Prahran (AU); Stuart Stanley Elliott, Glen Iris (AU); Eduardo VOM, Brunswick East (AU); Simon Jonathon Spence, East Trentham (AU); Stephen Bagnato, Keysborough (AU); Andrew Watkins, Port Melbourne (AU)

Correspondence Address: BANNER & WITCOFF, LTD., 1100 13th STREET, N.W., SUITE 1200, WASHINGTON, DC, 20005-4051, US

(73) Assignee: LEICA BIOSYSTEMS MELBOURNE PTY LTD, Mount Waverly (AU)

(21) Appl. No.: 11/867,760

(22) Filed: Oct. 5, 2007

Related U.S. Application Data
(60) Provisional application No. 60/828,499, filed on Oct. 6, 2006.

(30) Foreign Application Priority Data
Oct. 6, 2006 (AU) 2006905558

(51) Int. Cl. G01N 35/02

(52) U.S. Cl. 436/48; 422/62; 422/65; 422/57; 436/44

(57) ABSTRACT

Aspects of the present invention relate to laboratory systems for processing tissue samples and specimens within a laboratory. In particular, the present invention relates to a system for automating sample processing, comprising handling and analysis of tissue specimens with laboratory and/or medical diagnostic equipment. In one form the present invention relates to a method and apparatus for sample processing tissue specimens for histological and/or pathological laboratory analysis involving procedures or tasks such as, for example, tissue processing, embedding, staining, coverslipping and imaging. In a laboratory system utilizing aspects of the present invention there is provided at least one workcell and at least one conveyer in which tissue samples may be routed. Accordingly, there is provided therewith a first module for tissue sample processing adapted for operative association with a second module by the at least one conveyer for selectively accommodating and transporting at least one tissue sample container between the first and second module where the conveyor is adapted to engage a plurality of configurations of tissue sample containers and wherein each of the plurality of configurations of tissue sample containers corresponds to at least one particular tissue sample processing task.

### RELATED APPLICATIONS

This application claims priority to Australian Provisional Patent Application No. 2006905558 in the name of Vision Biosystems Limited, which was filed on 6 Oct. 2006, entitled “Method and Apparatus for Communicating Tissue Samples” and, also claims priority to U.S. Provisional Patent Application No. 60/828,499 in the name of Gurney et al., which was filed on 6 Oct. 2006, also entitled “Method and Apparatus for Communicating Tissue Samples” and the specifications thereof are incorporated herein by reference in their entirety and for all purposes.

### FIELD

Aspects of the present invention relate to laboratory systems for processing tissue samples and specimens within a laboratory. In particular, the present invention relates to a system for automating sample processing, comprising handling and analysis of tissue specimens with laboratory and/or medical diagnostic equipment. In one form the present invention relates to a method and apparatus for sample processing tissue specimens for histological and/or pathological laboratory analysis involving procedures such as, for example, tissue processing, embedding, staining, coverslipping and imaging. It will be convenient to hereinafter describe the invention in relation to the use of apparatus for transporting tissue specimens from one form of laboratory equipment to another, and laboratory equipment adapted for use with this transporting system, however, it should be appreciated that the present invention is not limited to that application, only.

### BACKGROUND

In general, for the purposes of this description the term “tissue sample processing” can be used to describe procedures or tasks for preparing tissue samples for microscopic examination and, traditionally, comprises embedding the tissue sample in paraffin wax and sectioning the paraffin-embedded tissue sample very thinly with a microtome. Thereafter, the thin sections may be floated onto glass slides, stained and finally coverslipped for microscopic examination. In particular, the sample processing of histology specimens may require a number of tasks to be carried out on tissue samples. For example, tissue processing infiltrates tissue samples with a medium such as paraffin wax, while embedding positions the tissue samples into a medium suitable for cutting thin slices at a microtome. After slicing the tissues using a microtome, the thin sections may be placed onto microscope slides, baked to ensure adhesion to the slide, and then stained to show the desired features of the tissues, where staining processes may comprise at least one of H&E, IHC, ISH and special stains. Once the tissue is stained, a coverslip may be placed over the tissue, and the tissue may then be imaged to capture a digital representation of the tissue sample. The stained microscope slides may then be collated into cases and the slides (and images where these are used) passed on to a pathologist for diagnosis. A number of ancillary tasks may also be considered to fall under the term of tissue sample processing, tasks such as ordering and sorting of samples that have undergone one or more mainstream tasks such as staining, and other procedures such as the management of reagents used in preparing the samples for analysis by a pathologist, which may comprise handling and allocation of such reagents in the laboratory environment.

The various tissue sample processing functions have historically been carried out manually, but in more recent times the advent of automated machines has allowed some of the separate tasks to be automated. Having more machines may increase throughput, but without connection of these machines it requires a human operator to choose which machine to run which operation on. Accordingly, the histology laboratories of today may be typified by islands of automation, and human interaction is still required throughout the handling of samples to move samples from one machine to another, and to ensure that the samples are processed in the correct order and are delivered to the pathologist in a timely manner. It would therefore be desirable to at least minimize the human interaction required, improving processing quality and timeliness of delivery of samples to the diagnostic pathologist, and hence reducing time to diagnosis of the patient.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

### SUMMARY

In one aspect of the embodiments described herein there is provided a method of processing samples comprising the steps of:

loading sample carriers into a sample container;
identifying a destination for the sample container;
conveying the sample container to a processor; and
loading the sample container into the processor and processing the samples according to predefined steps.

In another aspect of the embodiments described herein there is provided a method of routing a plurality of tissue samples in a laboratory for sample processing, the method comprising the steps of:

selectively transporting a plurality of tissue samples in at least one tissue sample container to a plurality of sample processing modules where each module is adapted to perform at least one sample processing task; and
communicating with at least one of the modules and the tissue sample containers to convey information operatively associated with the sample processing.

The step of selectively transporting may itself comprise the step of:

accommodating the at least one tissue sample container on a conveyor adapted to engage a plurality of configurations of tissue sample containers.

The step of accommodating may itself comprise the step of:

releasably engaging connecting means of the conveyer with corresponding releasable connecting means disposed on each of the configurations of tissue sample containers.

Each of the plurality of configurations of tissue sample containers may correspond to at least one particular tissue sample processing task.

The step of selectively transporting may comprise at least one of the steps of:

bypassing at least one module; and
temporarily parking tissue samples proximate to at least one of a module and the conveyer.

This preferred method may further comprise the step of:

sorting tissue samples to optimize tissue sample processing.

The step of sorting may comprise at least one of:

moving tissue samples from one container to another;
rearranging tissue samples within a container;
performing at least one of the steps of moving and rearranging at the conveyer;
performing at least one of the steps of moving and rearranging at one or more modules;
performing at least one of the steps of moving and rearranging remotely from the conveyer; and
performing at least one of the steps of moving and rearranging remotely from the modules.

The step of sorting may further comprise processing the information that is operatively associated with the sample processing in accordance with predetermined criteria. The predetermined criteria may comprise scheduling information.

This preferred method may further comprise the step of managing reagents for use in at least one module. The step of managing reagents may itself comprise at least one or a combination of:

storing reagents for use over time;
refrigerating reagents;
conveying reagents between modules;
tracking reagent use;
scheduling reagent use; and
collecting and disposing of waste reagents from modules.

The above step of conveying reagents between modules may comprise the following steps:

selectively transporting at least one reagent container on a conveyor adapted to engage one or more of;
reagent containers comprising one or more configurations; and
carrying means for carrying a plurality of reagent containers comprising one or more configurations.

Each of the plurality of configurations of reagent containers may correspond to at least one particular tissue sample processing task.

Preferably, the conveyer used for selectively transporting at least one reagent container comprises the conveyer as described above.

This preferred method may further comprise the step of scheduling at least one of the previously described method steps, wherein the step of scheduling itself may comprise at least one or a combination of the following steps:

prioritizing sample processing tasks;
prioritizing the selective transport of tissue samples;
prioritizing the communication of information operatively associated with sample processing;
prioritizing the step of sorting;
prioritizing the step of managing reagents; and
prioritizing the step of conveying reagents.

Preferably, the step of scheduling is performed by a controller at one or more of:

a module;
a point on the conveyer; and
a controller point remote from the conveyer and the modules.

This preferred method may further comprise the step of providing the controller with one or a combination of:

information from at least one module corresponding to at least one of capabilities of the module; status of the module; samples that are processed by the module; time required for processing samples; reagents required by and in use by the module; minimum and maximum processing times of a module;
information from the conveyer corresponding to at least one of capabilities of the conveyer; status of the conveyer; tissue samples that are conveyed by the conveyer; instructions for conveying samples; time required to convey samples;
information from a Laboratory Information System (LIS) corresponding to at least one of identity of tissue samples; processing protocols for samples; status of samples; grouping of samples;
information corresponding to minimum and maximum holding times for samples at buffer locations on the conveyer or at one or more modules;
information corresponding to priority of tissue samples for sample processing;
information applied to or in relation to tissue sample containers or tissue sample carriers;
information corresponding to laboratory cutting rules;
information corresponding to the location of a tissue sample, tissue sample carrier or a tissue sample container;
information relating to the usage and storage of reagents; and
information manually entered by a user.

Preferably, the above described step of scheduling further comprises the step of tracking tissue samples, wherein the step of tracking itself may comprise determining one or more of:

the identity of a tissue sample; and
the location of a tissue sample.

Preferably, the step of tracking may further comprise the step of identifying at least one of:

a tissue sample;
a tissue sample carrier; and
a tissue sample container.

Preferably, the at least one sample container comprises one or more of: a rack; a basket; and a tray. The tissue samples may be disposed on sample carriers. The sample carriers may comprise one or a combination of: Tissue cassettes; and Microscope slides. The at least one sample processing task performed by the preferred method may comprise one or a combination of:

tissue processing;
embedding;
microtoming;
slide baking;
dewaxing;
epitope retrieval;
sample sorting;
tissue staining;
coverslipping;
image capture;
image analysis;
transferring samples; and
reagent management.

In a further aspect of the embodiments described herein there is provided a conveyer for selectively transporting a plurality of tissue samples disposed in at least one sample container to a plurality of sample processing modules, each module adapted to perform at least one sample processing task, the conveyer comprising:

a receptacle for accommodating the at least one sample container, the receptacle being adapted to engage a plurality of configurations of sample containers; and
a plurality of interconnectable segments adapted to selectively form, upon interconnection, at least one guide path between modules;
wherein the receptacle is movably attached to the at least one guide path for conveying the at least one sample container to the plurality of sample processing modules.

The receptacle may comprise releasable connecting means for engaging corresponding releasable connecting means disposed on each of the configurations of tissue sample containers.

The conveyer may also comprise an interface for connection to a controller adapted for scheduling movements of the conveyer.

The conveyer may also comprise an interrogator for interrogating a data carrier applied on or in relation to a sample container. Data obtained by the interrogator may be used by the controller for one or a combination of:

verifying the identity of a sample container; and
determining one or more destinations for the sample container.

Preferably, the at least one guide path between modules extends through horizontal and vertical planes for x-y-z translation of the at least one sample container. Further, the guide path may comprise one or a combination of:

a linear configuration;
a loop configuration;
a star configuration; and
a mesh configuration.

It is preferable that the guide path is also adapted to bypass one or a combination of modules.

Preferably, the receptacle of the conveyer comprises a shuttle and the segments comprise a rail. In this respect, the shuttle may comprise a drip tray for collecting waste from a conveyed sample container.

It is also preferable that the conveyor comprises a transposing means for transposing articles from the conveyor to a module, wherein the transposing means may comprises a robot arm. The robot arm, preferably, comprises releasable connecting means for engaging corresponding releasable connecting means disposed on a plurality of configurations of articles comprising one of:

trays;
racks;
sample containers;
reagent containers; and
reagent carriers.

In a further aspect of the embodiments described herein there is provided a tissue sample processing module adapted to perform at least one sample processing task comprising:

a plurality of bays segregated into at least input, output and processing bays;
transposing means for transposing articles from one bay to another;
an interface between the bays and a conveyer for selectively transporting a plurality of articles disposed in at least one container to at least one further sample processing module; and
communication means for communicating information operatively associated with sample processing.

Preferably, at least one of the input bays and the output bays comprise a holding area for temporarily holding articles and this storage bay may be refrigerated. The input bays may also comprise STAT entry for priority processing. Furthermore, it is preferable that the storage bays themselves are adapted for receiving articles comprising at least one of:

a tissue sample carrier;
a tissue sample container; and
a reagent container.

The holding area may comprise one of a buffer area for holding samples under predefined conditions around the time of processing; and, a queuing area for positioning samples or containers around the time of a sorting procedure.

Preferably, the module further comprises at least one storage bay for storing one or a combination of:

at least one reagent container; and
at least one reagent carrier comprising a plurality of reagent containers.

The module may further comprise fluid transmission paths for providing one or a combination of:

a reagent supply to at least one module; and
a waste collection means for collecting waste reagents.

The module may also further comprise at least one interrogator for reading machine-readable data disposed on one or a combination of:

a tissue sample carrier;
a tissue sample container;
a reagent container; and
a reagent carrier comprising at least one reagent containers.

In a preferred form the transposing means comprises a robot arm, which may be adapted to move articles from bays to a conveyer. The robot arm itself may comprise releasable connecting means for engaging corresponding releasable connecting means disposed on a plurality of configurations of articles comprising one of:

trays;
racks;
sample containers;
reagent containers; and
reagent carriers.

The communication means of the module may comprise an interrogator for interrogating one of:

### RFID tags;

bar code labels, and

### OCR.

Further, the communication means may be adapted to communicate with a controller for scheduling sample processing tasks.

In yet a further aspect of the embodiments described herein there is provided a first module for tissue sample processing adapted for operative association with a second module by a conveyer for selectively accommodating and transporting at least one tissue sample container between the first and second module where the conveyor is adapted to engage a plurality of configurations of tissue sample containers and wherein each of the plurality of configurations of tissue sample containers corresponds to at least one particular tissue sample processing task.

In still another aspect of the embodiments described herein there is provided a workcell for tissue sample processing comprising:

a plurality of sample processing modules, each module adapted to perform at least one sample processing task;
transport means for selectively transporting a plurality of tissue samples in at least one tissue sample container to the plurality of sample processing modules; and
communication means for communicating with at least one of the modules and the tissue sample containers to convey information operatively associated with the sample processing.

Preferably, each of the plurality of configurations of tissue sample containers corresponds to at least one particular tissue sample processing task.

The transport means may comprise at least one diverter for bypassing at least one module. Further, the transport means may comprise temporary parking areas for parking tissue samples for optimizing throughput of samples for sample processing tasks. The workcell may further comprise a sorting module for sorting tissue samples to optimize tissue sample processing. The sorting module may be adapted to perform at least one of:

moving tissue samples from one container to another;
rearranging tissue samples within a container;
moving or rearranging at the conveyer;
moving or rearranging at one or more modules;
moving or rearranging remotely from the conveyer; and
moving or rearranging remotely from the modules.

In a preferred form, the sorting module further comprises means for processing the information operatively associated with the sample processing in accordance with predetermined criteria. The predetermined criteria may comprise scheduling information.

In another preferred form the workcell further comprises a reagent module for managing reagents for use in at least one module. The reagent module itself may comprise at least one or a combination of means for:

storing reagents for use over time;
refrigerating reagents;
conveying reagents between modules;
tracking reagent use;
scheduling reagent use; and
collecting and disposing of waste reagents from modules.

In this respect, the means for conveying reagents between modules may comprise:

transport means for selectively transporting at least one reagent container on a conveyor adapted to engage one or more of:
reagent containers comprising one or more configurations wherein each of the plurality of configurations of reagent containers may correspond to at least one particular tissue sample processing task; and
carrying means for carrying a plurality of reagent containers comprising one or more configurations.

Preferably, the conveyer used for selectively transporting at least one reagent container comprises the conveyer as described herein. It is also preferable that the workcell further comprises scheduling means for scheduling at least one processing task. As such the scheduling means is preferably adapted for at least one of the following:

prioritizing sample processing tasks;
prioritizing the selective transport of tissue samples;
prioritizing the communication of information operatively associated with sample processing;
prioritizing the step of sorting;
prioritizing the step of managing reagents; and
prioritizing the step of conveying reagents.

The scheduling means may comprise a controller at one or more of:

a module;
a point on the conveyer; and
a controller point remote from the conveyer and the modules.

The scheduling means may further comprise tracking means for tracking tissue samples, wherein the tracking means is adapted for determining one or more of:

the identity of a tissue sample; and
the location of a tissue sample.

Preferably, the tracking means is further adapted for identifying at least one of:

a tissue sample;
a tissue sample carrier; and
a tissue sample container.

The workcell may also comprise a controller which is adapted to receive and process one or a combination of:

information from at least one module corresponding to at least one of capabilities of the module; status of the module; samples that are processed by the module; time required for processing samples; reagents required by and in use by the module; minimum and maximum processing times of a module
information from the conveyer corresponding to at least one of capabilities of the conveyer; status of the conveyer; tissue samples that are conveyed by the conveyer; instructions for conveying samples; time required to convey samples;
information from a Laboratory Information System (LIS) corresponding to at least one of identity of tissue samples; processing protocols for samples; status of samples; grouping of samples;
information corresponding to minimum and maximum holding times for samples at buffer locations;
information corresponding to priority of tissue samples for sample processing;
information applied to or in relation to tissue sample containers or tissue sample carriers;
information corresponding to laboratory cutting rules;
information corresponding to the location of a tissue sample, tissue sample carrier or a tissue sample container; and
information manually entered by a user.

In the embodiments disclosed herein the at least one sample container may comprise one or more of:

a rack;
a basket; and
a tray.

In the embodiments disclosed herein the tissue samples may be disposed on sample carriers.

In the embodiments disclosed herein the sample carriers may comprise one or more of:

tissue cassettes; and
microscope slides;

In the embodiments disclosed herein the at least one sample processing task may comprise one or more of:

tissue processing;
embedding;
microtoming;
slide baking;
dewaxing;
epitope retrieval;
sample sorting;
tissue staining;
coverslipping;
image capture;
image analysis;
transferring samples; and
reagent management.

In a further aspect of embodiments described herein there is provided apparatus adapted to communicate a plurality of tissue samples in a laboratory, said apparatus comprising:

processor means adapted to operate in accordance with a predetermined instruction set, and
said apparatus, in conjunction with said instruction set, being adapted to perform the method steps as disclosed in claimed in any one of the methods described herein.

In a further aspect of embodiments described herein there is provided a computer program product comprising:

a computer usable medium having computer readable program code and computer readable system code embodied on said medium for communicate a plurality of tissue samples in a laboratory within a data processing system, said computer program product comprising:
computer readable code within said computer usable medium for performing the method steps of any one of the methods described herein.

In a further aspect of embodiments described herein there is provided a method of automatically scheduling tests to be conducted on tissue samples based on the results of analysis of a section of the sample, comprising:

cutting one or more sections from a sample;
staining one or more of these sections;
image capture of the resulting stained sample sections;
image analysis of the resulting images;
using the results of the image analysis to determine the need for further testing, and
automatically scheduling and performing further testing on the tissue sample.

Other aspects and preferred embodiments are disclosed in the specification and/or defined in the appended claims, forming a part of this description.

Further scope of applicability of the present embodiments will become apparent from the detailed description given hereinafter. However, it should be understood that the detailed description and specific examples, while indicating preferred embodiments, are given by way of illustration only, since various changes and modifications within the spirit and scope of the disclosure herein will become apparent to those skilled in the art from this detailed description.

### BRIEF DESCRIPTION OF THE DRAWINGS

Other features and advantages of one or more preferred embodiments will be readily apparent to one of ordinary skill in the art from the following written description with reference to and, used in conjunction with, the accompanying drawings, which are given by way of illustration only, and thus are not limiting to the scope of the present invention, and in which:

FIG. 1 is a plan view of an exemplary module according to an embodiment described herein.

FIG. 2 is a perspective view of a number of modules in communication via a conveyer and waste management system according to an embodiment described herein.

FIG. 3 is a detailed view of a conveyer system according to an embodiment described herein.

FIG. 4 is another detailed view of a conveyer system according to another embodiment described herein.

FIG. 5 is a further detailed view of a conveyer system showing a means of providing information and identification according to an embodiment described herein.

FIG. 6 is a schematic view of a workcell in a first configuration according to an embodiment described herein.

FIG. 7 is a schematic view of a workcell in a second configuration according to an embodiment described herein.

FIG. 8 is a top view of a workcell in a third configuration according to an embodiment described herein.

FIG. 9 is a top view of a workcell in a fourth configuration according to an embodiment described herein.

FIG. 10 is a top plan view of a bypass means according to an embodiment described herein.

FIG. 11 is a detailed perspective view of a conveyer system as described in embodiments herein.

FIG. 12 is a block diagram showing the use of a workcell according to an embodiment as described herein.

FIG. 13 is a scheduling diagram displaying a first and a second scheduling arrangement according to embodiments disclosed herein.

FIG. 14 is a detailed perspective view of one aspect of a reagent management system according to embodiments described herein.

FIG. 15 is a scheduling diagram displaying a first and second reagent-management scheduling arrangement according to embodiments herein.

FIG. 16 is a perspective diagram showing two sample carriers together with machine and human-readable identifiers.

### DETAILED DESCRIPTION

Modules

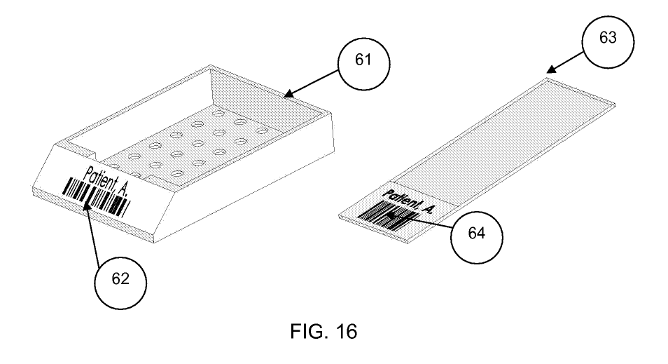

In preferred embodiments, modules within a workcell are designed to perform processing tasks on samples disposed on sample carriers such as tissue cassettes 61 and microscope slides 63, as shown in FIG. 16. Modules available for use within a workcell comprise those that conduct tasks required to automate preparation of histological samples. Workcell modules may be provided for any suitable function, including tissue processing, sample embedding, microtomy, slide bake, slide dewax, sample sorting, transfer of samples from one container to another, epitope retrieval, staining (e.g., H&E, IHC, ISH, special stains), coverslipping, slide imaging, image analysis and reagent management. One or more of these functions may be combined into a single module, and modules can be designed to be expandable so that further processing functions can be added within the module.

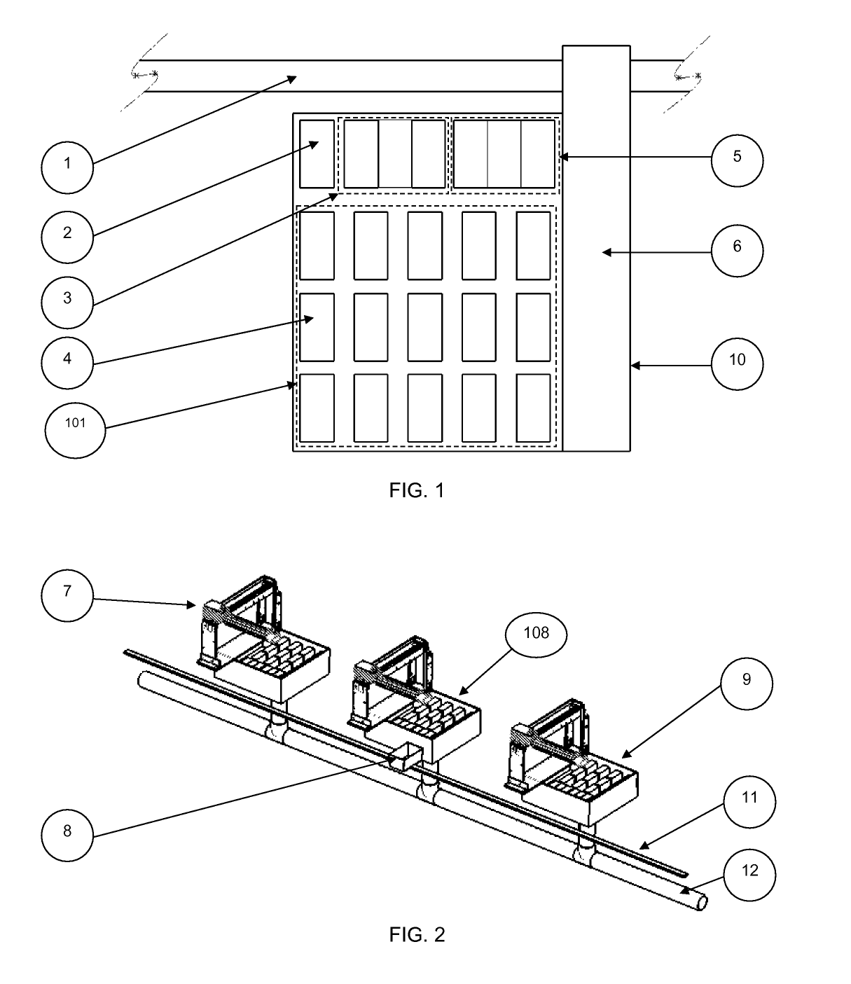

With respect to FIG. 1, in a first embodiment, there is shown a module 10 having a stat input area 2, an input 3, a processing region 4, and an output 5. In this case the input, output and processing region have a number of individual regions for processing samples. The module is designed such that it can prioritize samples from the STAT input 2 over those from the standard input area 3.

A typical module may be an Autostainer where each region may hold a reagent and a rack of slides. A robotic arm 6 may be used to load racks of slides from and to the conveyer 1.

A similar arrangement may also be applicable to instruments such as automated immunohistochemistry stainers such as a Bond-max instrument as sold by the applicant. In such a case the instrument would load trays of slides rather than racks. The design of module 10 may be such that it may be operated either as a stand-alone instrument, or combined together with a conveyor and scheduler to form a workcell. The module 10 has input 3 and output 5 (I/O) areas, located in one form outside the processing footprint of the module shown at 101 in FIG. 1. In another form the input and output modules may be located within the processing footprint (not shown). Samples in carriers are placed in this I/O area prior to, and after, operation of the module 10 on the samples in processing area 101. The I/O areas may consist of a number of separate bays, (three each are shown for input 3, and output 5 areas) where sample carriers may be held. When operated as a stand-alone instrument, this I/O area 2, 3, 5 may be a static platform, which may be replaced by a conveyor system 1 when the modules are combined into a workcell.

Tissue samples are fragile and easily damaged, for example by drying out. Within the input areas 2, 3, output 5, and/or processing 101 area 5 of a module 10, a suitable buffer area may be provided where samples may be held in conditions appropriate to the processing stage of the sample. For example, a formalin, water or xylene bath may be provided in which to hold samples. The samples can then be moved to this area before or after samples are processed in the module 10, thus ensuring that samples are not damaged prior to, or after, processing.

The internal layout of module 10 is shown schematically only. In the example shown in FIG. 1, a number of sample processing areas, 4 are shown. This layout may be applicable, for example, for an H&E staining module, where processing of samples within the module is carried out by moving samples between processing areas, 4, which may contain a variety of reagents such as alcohols, haematoxylin and eosin. It will be clear that the invention is not limited by the internal layout of the modules, and that other internal layouts would be more suitable for processing operations such as coverslipping or imaging.

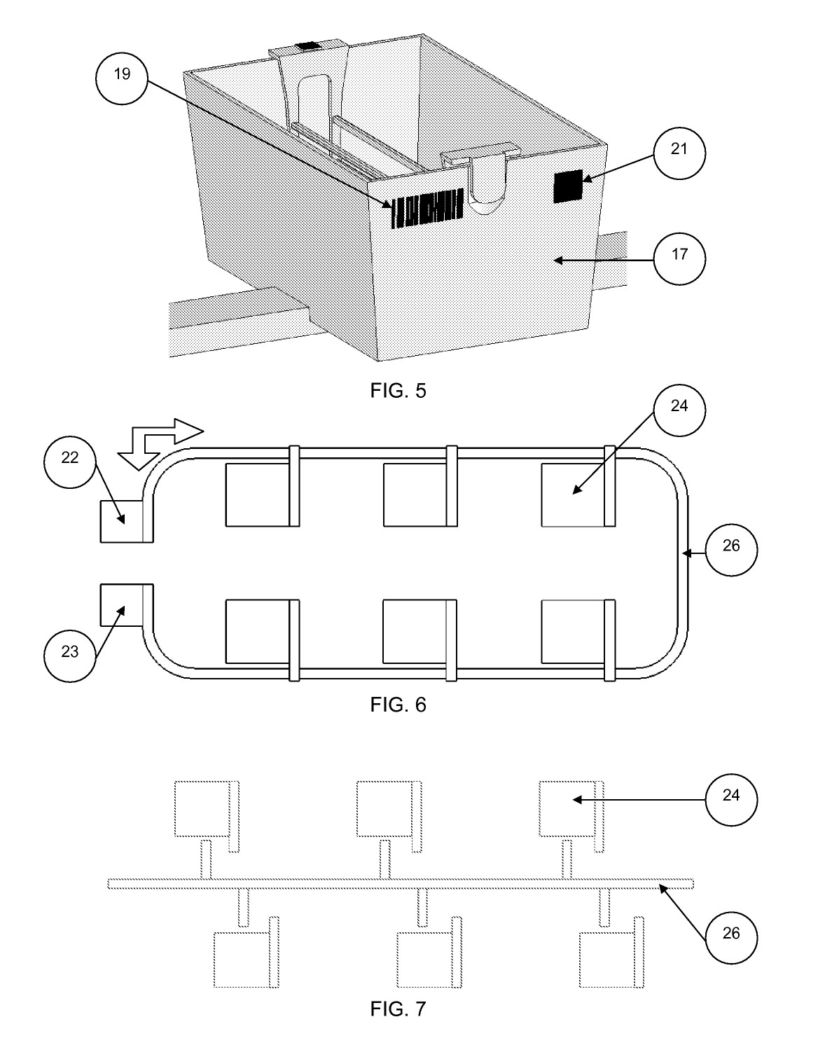

Each module 10 has a transposing means which in a preferred embodiment comprises the robotic arm 6, but dependent on module function and internal layout may be any other means designed to reach to the input 2, 3 and output 5 areas and convey sample containers from this area to the processing areas 4 of the module 10. Modules may be provided with means to identify sample containers and the samples within them. For example, with reference to FIGS. 3, 4 and 16, an interrogator (not shown) may be provided to read labels (e.g., bar codes, OCR characters) or tags (e.g., RFID tags, electrically or magnetically interrogatable memory devices) on the sample carriers (62, 64) and sample containers 14, or an electrical connection may be provided to the sample container to interrogate electrically readable tags on the sample carriers and containers. In FIG. 5 there is shown the examples of a bar code 19 and RFID tag 21 on the conveyor system. Each module 10 is provided with a means of transporting sample containers between the input 2, 3 and output 5 areas of the module and the conveyor. In the example module shown schematically in FIG. 1, the robot arm 6 provides this function. Alternately (not shown) a robotic arm may be provided as part of the conveyor system 1, such that a robotic arm, which may move along the conveyor with the sample containers, is arranged to reach to the input 2, 3 and output 5 areas of the modules 10.

Each module is provided with the ability to communicate to a scheduler. This information communication path may be wired or wireless. Information that may be communicated to the scheduler may comprise information relating to the capabilities of the module, the status of the module (including error messages), the sample carriers and samples that the module is currently processing, instructions relating to the processing of samples, the time that the processing will take, and the reagents required by, and in use on the module. Modules may also be provided with an information connection to the laboratory information system (LIS), which may hold data regarding the correct processes for application to samples.

The module may receive sample carriers and be told via a central controller or LIS system, what samples are arriving. The module may then perform the specified operations on the samples. Alternatively, the module may have an interrogator that reads an identifier to ascertain what samples are presented. In one form the interrogator may read for example the rack of slides, and interrogate the central controller to ascertain the test or tests to be applied. In another form the interrogator may read each slide in a tray and ascertain the individual tests to be applied to each slide. Test information may be encoded into the sample identifier, or the label on each slide, or other means. The interrogator may be on the instrument, associated with the conveyer at the point where the samples are to be loaded and unloaded to a module, in a wait station or other suitable location.

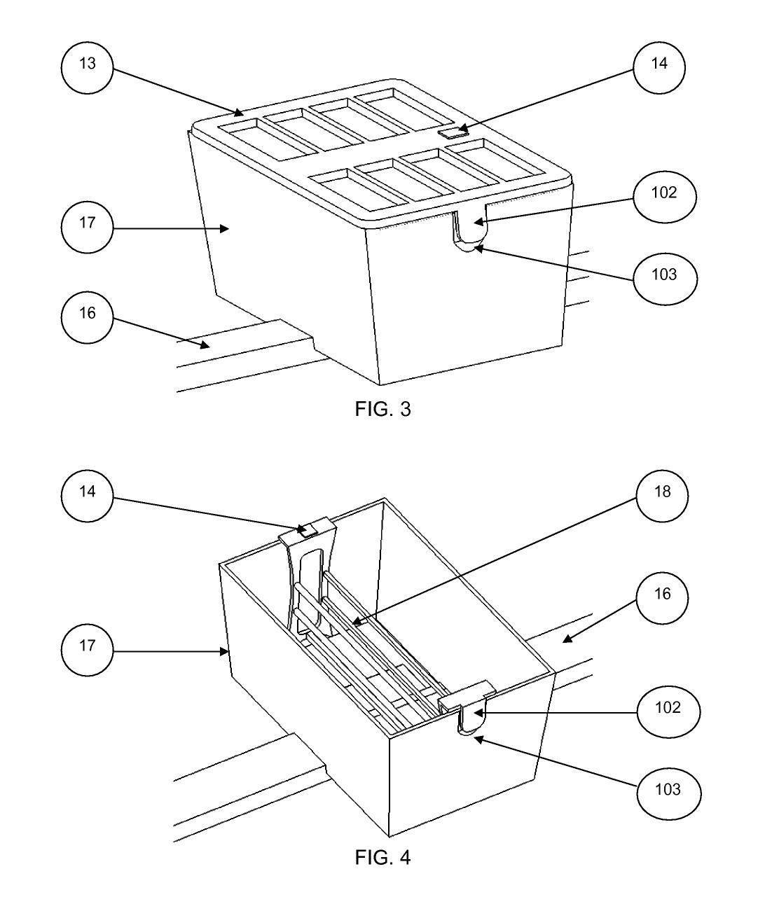

Optionally, modules may be provided with waste collection and power connectors that may be used to link the modules to other modules within a workcell. FIG. 2 shows a non-hazardous waste line 12 as an example.

With reference to FIGS. 6, 7, 8, 9 and 12, a workcell is formed by the combination of multiple processing modules, a conveyor and a scheduler (not shown). In a typical laboratory, according to a preferred embodiment there may be two workcells, one that handles samples in tissue cassettes and provides sample processing functions such as tissue processing and embedding, and a second workcell that handles samples on microscope slides, and provides functions such as staining, coverslipping, imaging and sorting. The two workcells can be linked together by a conveyor taking embedded tissue cassettes from the output of the tissue processing workcell to the microtome, and a second conveyor that carries microscope slides from the microtome to the input of the staining workcell.

It is noted that embodiments provide for workcells that are modular, scalable and configurable. Modular implies that multiple modules can be connected together in a way that the user defines to provide the desired sample processing functions. Scalable implies that multiple similar processing modules can be combined into a workcell to increase processing capacity. Configurable implies that the modules can be combined in a fashion that allows a workcell to fit within the available space in a laboratory. For example, one laboratory may conduct a large number of H&E stains and no IHC stains, so they may choose to configure a workcell that includes multiple H&E modules, and a single coverslip module connected in linear fashion. Another laboratory may choose to configure a workcell that combines modules in a different way, such as a single H&E module, an IHC module, a coverslipper module, an imager module and a sorting module, which may be linked in an L-shape to overcome workspace restraints.

In preferred embodiments, modules may be designed so that they may be linked together to form a workcell, and ancillary functions may also be provided by a workcell to streamline the operation of a histology laboratory.

Samples and Containers

With reference to FIGS. 3, 4 and 5, samples to be processed within the modules may be held by carriers that are suitable for the processing stage of the sample, for example tissue cassettes and microscope slides. In the present description, sample carriers are defined to comprise microscope slides and/or tissue cassettes as appropriate. Examples of sample carriers are shown in FIG. 16, where a tissue cassette 61 and slide 63 are shown with identifiers 62 and 64 respectively. In the figure, the identifiers 62 and 64 are printed bar codes and may include additional information in human readable form. Sample carriers may be supplied with any suitable machine-readable identifiers such as barcodes 19, RFID tags 21 and the like, and in addition may carry human-readable identifiers. The machine-readable identifier may be used to specify the processing task required for the sample, or may be an identifier unique to the sample carrier, and which can be associated in some manner with the required processing for the sample.

In one embodiment, sample carriers are grouped into containers, for example 13, 18 as shown in FIGS. 3, 4 and 5 adapted to hold one or more carriers and for which all of the samples in the container require similar processing. These containers come in various forms, designed to best suit the operation of the different modules within a workcell. For example, a module may operate in a batch-process mode, where all samples within the module undergo the same processing—a basket or rack 18 may be the best container for this form of process. Another module may operate on a group of samples, but deliver different processing to individual samples within the group—a tray 13 may be the best container for this type of operation. Yet another module may accept samples that have been processed in a variety of formats, and so may require the ability to handle more than one format of container.

Sample containers may be moved along a common conveyor system 16, and the dimensions and features of the sample containers are such that they fit within a receptacle 17. The receptacle 17 may be releasably attached to the conveyor. However, the dimensions of the sample containers may be chosen to be different from each other, such that the height, length and width of a basket may be different than the height, length and width of a tray. The workcell may use the dimensions of the container to specify the processing module required for processing of samples within the container. In one form the sample container, being a tray 13 and rack 18, have elements that allow either container to engage with the receptacle 17. As can be seen in FIGS. 3 and 4, the same receptacle 17 is adapted to carry two different sample containers. If other sample containers are used then they may also be adapted to fit a common receptacle 17.

By allowing for modules to be designed to use the type of container most suitable for the operation of the module, the design of the processing within the module is simplified, leading to a lower cost for the module. Depending on the function of the module, a module may be designed to handle one, or more than one type of container. For example, an H&E staining module that uses a dip-and-dunk staining process may only handle microscope slides in racks, while a coverslipper module that handles slides from both H&E and IHC processes may be designed to handle both racks and trays as input formats.

When multiple modules are combined into a workcell, sample containers must pass between the different modules on a conveyor as necessary for the operation of the workcell. By using a common set of locating features (e.g., an arrangement of hooks, indentations, magnets etc) on the containers (an example is shown at 102 in FIGS. 3 and 4) that engage with a similar set of features on the conveyor or some portion of the conveyer (an example is shown at 103 in FIGS. 3 and 4), it is possible to use the same conveyor to carry all forms of container, be they trays or racks (as illustrated in FIGS. 3, 4 and 5) or baskets or some other suitable format. Similarly, the design of the robot arm to remove the containers from the conveyor may be simplified by using a common set of features on the containers that engage with a set of features on the robot arm.

The sample containers (trays, racks, baskets etc) may be supplied with machine-readable identifiers 14, such as barcodes, RFID tags or the like, and may also bear human readable identifiers such as color coding, text or the like. The container may additionally include a means of identifying the sample carriers within it, such as a memory device. The container identifier may be used in a number of ways, for example it may be specific to a particular processing path within the workcell, with similar containers carrying identical markings, or it may be unique to the container, with information linked to that unique identifier by a system within the workcell.

As an example, a blue colored rack may be used to indicate to an operator that the slides contained within it will be processed in the H&E module and then coverslipped. The machine-readable identifier on all of the blue racks may be the same, and the workcell may be configured so as to schedule all racks with this identifier on them to pass first to the H&E module, and then to the coverslip module. Alternately, a slide tray may have a unique identifier, and using an information system this identifier may be linked to the identity and position of the samples on the tray. In this way, an IHC staining module may be configured to recognize the correct reagents and protocol for each slide within the tray.

Conveyor System

Again with reference to FIGS. 3, 4 and 5 a conveyor is used as a selective transport system to provide a means of physically moving samples from one module to another. The conveyor system is arranged to pass by the input and output areas of modules, allowing sample containers to be delivered to an I/O area accessible by a robotic arm that may be located on the conveyor or module. For example, the robotic arm of a staining module may place a rack of slides onto the conveyor when staining is completed. The conveyor may then move the rack to the coverslip module, where the robot arm of the coverslip module removes the rack of slides from the conveyor, ready for coverslipping. An example of a number of modules 7, 108 and 9 is shown in FIG. 2 where a receptacle 8 moves along the conveyor 11. The conveyor may alternatively stop at the module to unload the sample container, or may keep moving whereupon the module ascertains the receptacles position and removes the appropriate container. In one form the module may interrogate the container for an identifier and if the correct identifier is located, then the robotic arm may remove the container. In another form, the module may interrogate the receptacle 17 for an identifier (e.g., 19, 21) and interrogate the scheduler to link this identifier to the identity of the container carried by the receptacle.

The conveyor is designed to accommodate all types of sample container. Features on the sample containers are arranged so as to engage with similar features on the conveyor, holding the containers in place when the conveyor moves. The conveyor is configured to allow samples to be delivered to, and picked up from, modules in the system workcell in any order. This requires that if a module overhangs the conveyor, then the distance of the conveyor relative to the part of the module that overhangs the conveyor is such that even the largest sample container can pass along the conveyor.

The conveyor optionally has an information connection that allows it to interface to the scheduler, with the movements of the conveyor being dictated by the scheduler. The conveyor system may be provided with an interrogator that can be used to interpret the machine-readable identifier on the sample carriers and/or containers. This data can be passed to the scheduler, and the scheduler may use this to verify the identity of the sample container and to determine the next location for the container. By using an interrogator on the conveyor module, there may be no need to supply the modules with separate interrogators to identify the sample containers.

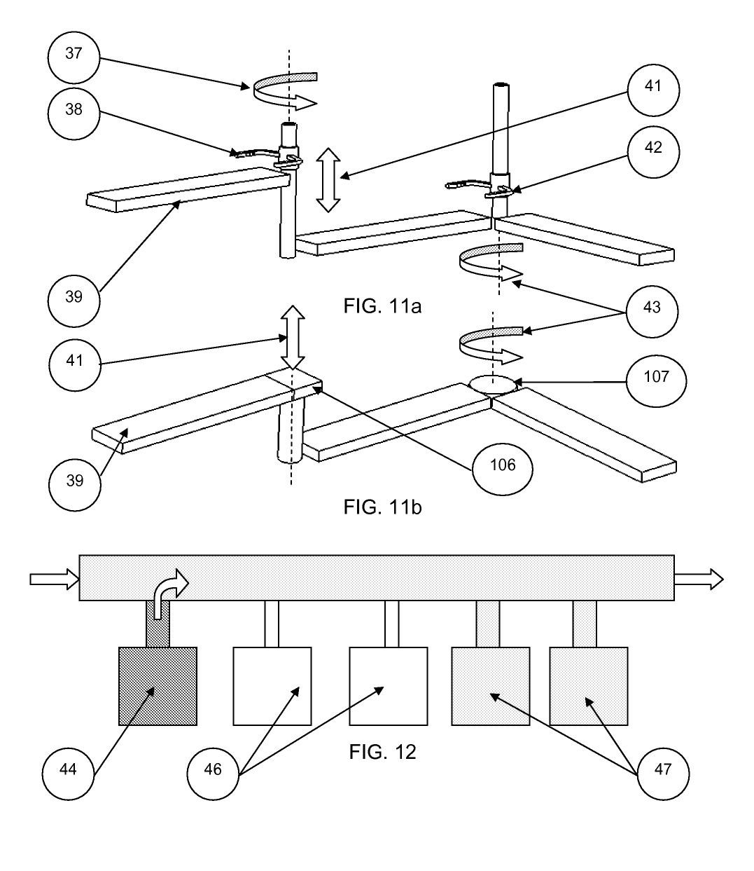

With reference to FIG. 11, the conveyor may be designed to allow movement in both horizontal and vertical planes, and may be formed from multiple segments connected together. An example of how this might be achieved is shown in FIG. 11 a, where a rail 39 of the conveyer leads to a pivot axis 37 and a receptacle 17 containing samples such as that shown in FIGS. 3, 4 and 5 engages gripper 38, pivots at 37 and is lowered 41 to a second rail. The samples are then engaged with gripper 42 and pivoted 43 to continue along a third rail at a different height and extending in a different direction at least as compared to the first rail 39. This allows for modules that are stacked vertically, or placed side-by-side horizontally. A similar functionality can be achieved with the system shown in FIG. 11 b. Here the conveyor includes a platform 106, shown in its upper position. Shuttles 17 (not shown) may move along the rail 39 until they reach the platform. The platform 106 is then lowered, and the shuttle continues along the lower rail until it reaches the pivot 107, which rotates, moving the shuttle 17 to a third rail a different height and extending in a different direction at least as compared to the first rail 39. Further, this design allows the workcell to be adaptable to the circumstances of the lab, to accommodate the varying physical dimensions of the modules and the work area in which they are located, and to enable suitable physical access to modules for example to access to service areas.

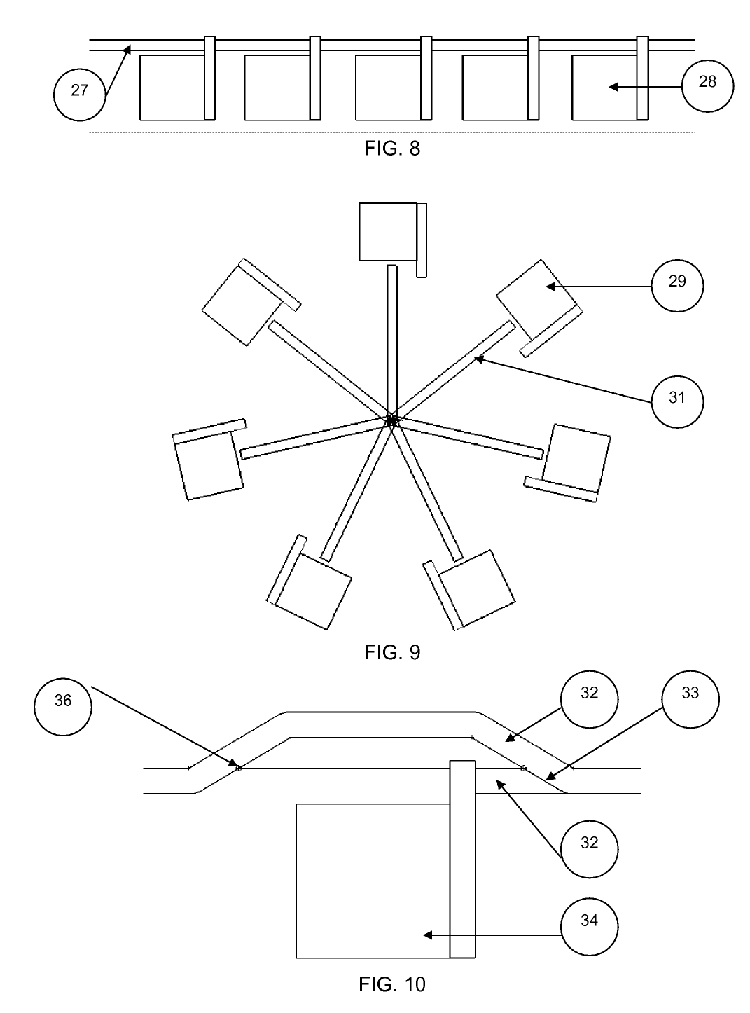

With reference to FIGS. 6 to 9 the conveyor may use any suitable layout that allows connection to all modules in a workcell, for example the conveyor may be linear as in FIGS. 7 and 8, or take the form of a loop as in FIG. 6, star as in FIG. 9 or even a mesh. With reference to FIG. 10, as samples will not generally require to be processed in all modules of a workcell, there may be a means by which samples can bypass a module. Bypass can be achieved in a number of ways—for example modules may be connected in a linear fashion, and the conveyor can simply move samples past the input/output area of the modules to be bypassed until they reach desired module. FIG. 12 shows an example of such bypassing where module 44 has its processing complete but modules 46 are not to be used in the particular protocol for processing, instead the sample proceeds to one of the modules 47. Alternately, the conveyor can be designed using a multiple physical paths between modules, allowing for samples to bypass the input/output areas of modules. FIG. 10 shows a diverter 33 on a rail 32 where samples may be diverted from a module 34 at pivot 36.

Movement of samples between processing modules may be complicated by the fact that it is often necessary to maintain samples under specific conditions prior to the next processing step (e.g., slides that have been deparaffinized may require to be kept wet while waiting for processing). The samples may be kept under ideal conditions by provision of a buffer area at the input or output of each module, where samples can be held prior to, or after, processing. Such an area may be termed a wait station, and may be incorporated into some or all modules, or may comprise its own module to allow additional flexibility in scheduling. A wait station typically would comprise a number of areas where containers could be placed for a period of time where no processing was undertaken, but where the samples would not be subject to degradation. Such a station may have temperature and humidity control to prevent sample damage or drying, and may have containers of fluids such as buffer or xylene to hold samples. A wait station may also have a robotic arm to dispense fluid onto sample carriers such as slides to ensure the samples stay moist.

With reference to FIGS. 2, 3 and 4, as a simple example of a conveyor system, a system may be provided in which a shuttle 17 is mounted on a rail 16 that can be arranged to pass past the input and output areas of modules. Under the directive of the scheduler, the shuttle 17 can be made to stop to deliver containers of samples to modules, and pick them up from modules. Features 102 on the sample containers 13 in FIGS. 3 and 18 in FIG. 4 are arranged so as to engage with similar features 103 on the shuttle 17, holding the containers in place when the shuttle moves. The rail 16 may be made from multiple segments (better shown in FIG. 11, and the shuttle 17 can move both backwards and forwards along the rail 16, to allow samples to be delivered to, and picked up from, any module in the workcell in any order. The rail 16 may be arranged as with a roller coaster to move around corners and in a vertical plane. As illustrated in part by FIG. 11, alternately, a system may be used to provide segments that allow for x-y-z translation of the shuttle, which connect to the rail as necessary. The shuttle may also provide a drip-tray to catch waste reagents that may fall from the sample containers, and there may be a cleaning station provided to automate cleaning of the shuttle. A workcell may include multiple shuttles, each separately identified to the system (for example by identifiers 19, or 21 shown in FIG. 5)

As mentioned earlier, it is likely that a lab may choose to have two workcells, one that handles tissue cassettes, and provides functions such as tissue processing and embedding, the other handling slides, and carrying out functions such as staining, coverslipping and imaging. These separate workcells may be connected to a microtome workstation area by means of two conveyor systems, one carrying containers of cassettes to the microtome workstation, and a second carrying containers of slides, or single slides, from the microtome workstation. These conveyors may have the same location features as the conveyor within the workcells, and could form the input and output areas of the respective workcells.

Scheduling

In operative association with the workcell is the scheduler, a system that organizes the functions of the conveyor and the modules to control the operation of the workcell, and regulate the movement of samples through the workcell. The tasks of the scheduler may comprise ensuring that samples are processed correctly within the workcell, prioritization of samples and containers, overcoming conflicts in the use of shared resources, management of the conveyor system, generation of status reports, and optimization of the throughput of the workcell according to user-definable criteria. The function of the scheduler may be performed within any of the modules of the workcell, or within the conveyor system, or may be provided by a separate part of the workcell. In one form the scheduler may be incorporated into a central controller (not shown) that is associated with an input apparatus for the workcell, such as a sorting module 22 described below.

The scheduler is provided with information connections to a variety of systems in order to enable it to perform its tasks. The information pathways may be wired or wireless, and can be provided by any suitable means.

The scheduler is provided with an information connection to the modules within a workcell. Information that may be communicated between modules and the scheduler comprises information relating to the capabilities of the module, the status of the module (including error messages), the sample carriers and samples that the module is currently processing, instructions relating to the processing of samples, the time that the processing will take, and the reagents required by, and in use on the module.

The scheduler may be provided with an information connection to the conveyor system. Information that may be communicated between the conveyor system and the scheduler comprises information relating to the capabilities of the conveyor, the status of the conveyor (including error messages), the availability of the I/O bays and buffer areas, the sample carriers and samples that the conveyor is currently carrying, instructions relating to the disposition of sample carriers (e.g., to move the sample carrier from module A to module B), and the time that the conveyance of sample carriers will take. Alternatively the scheduler may control the conveyor system directly, directing receptacles to the correct module.

Additionally, the scheduler may be provided with information connections to the laboratory information system (LIS), either by a direct connection to the LIS, or via information passed to the scheduler by modules that are connected to the LIS. Information that may be communicated between the LIS and the scheduler comprises information regarding the identity of samples, the required processing for samples, the status of samples (e.g., how far through the workcell a sample has progressed), the number of, and required processing for, the samples expected to be delivered to the workcell, and the required grouping of samples.

Further, the scheduler is provided with information that may be hard-coded, or may be accessed from modules when they are added to the workcell, or when they are upgraded. This comprises information regarding minimum and maximum processing times for modules and minimum and maximum holding times for samples to be held in buffer areas. Further, user supplied information, such as the priority of certain samples can be entered into the scheduler.

The scheduler may also be provided with information that enables it to determine the processing steps required for a particular sample or collection of samples. This data may be provided in a number of ways. For example, a sample container may be provided with an identifier that specifies the required processing for the samples within that container.

The sample processing information may be available from the LIS, and accessed through the connection between the scheduler and the LIS. Often, however, the sample processing information for histological samples is not available in the LIS, which in a histology laboratory may be used primarily to assist in billing. The sample processing information is, however, generally available at the microtome workstation, in the form of cutting rules. For example, a lab may require that for one type of tissue, both a regular H&E stain and an IHC stain are to be carried out for all samples of that tissue, while for other types of tissue only an H&E stain is ordered initially, and an IHC stain may be optionally ordered if the review of the H&E stained slide warrants further investigation.

By delivering to the workcell scheduler information about the laboratory cutting rules for handling samples, the workcell will be able to determine the processing requirements for a particular sample without reference to the LIS. By interfacing the scheduler to a system such as described in patent application AU2006901906 and/or U.S. 60/744,632 the processing data derived from the laboratory cutting rules can be tagged to the sample at the time of microtomy. The workcell scheduler can then use the physical location of the sample, or some machine-readable identification attached to the sample, to infer the required processing for the sample.

There are therefore a number of ways in which information regarding the processing of a sample may be made available to the workcell scheduler. The information may be inferred from cutting rules at the time of microtomy, may be made available by interfacing to a system such as described in patent application AU2006901906 and/or U.S. 60/744,632, may be accessed directly from an LIS system, may be determined from the identity of the container in which the sample is sample is held, or may be entered by the user.

The scheduler may track samples through the workcell in an appropriate fashion. Some sections of a workcell will be required to know the identity of each slide, for example IHC and special staining modules where staining protocols vary from slide to slide. Still other modules may only be required to identify the container of samples, rather than the individual samples, for example an H&E stainer where all slides delivered to that module require the same staining protocol. A number of identification protocols are therefore applicable to samples within a workcell. The workcell may include a module with the ability to automatically identify all sample carriers within a container, and the identity may be communicated to the scheduler. Alternately, for example, a human could use a system linked to the scheduler to manually scan in all identities of samples within a container, and may link this to the identity of the container prior to entering the container into the workcell.

The scheduler may use a hierarchal database to track the identity and location of the samples. For example, the identity of the container may be linked to information relating to the identity and physical location of samples within the container, and the identity of the samples could be linked to the processing required for the samples. In this way, the scheduler may need only to identify the container to be able to access the information required for the processing of the samples.

The information regarding the required processing for a sample or container of samples allows the scheduler to determine the processing steps required for a sample within the workcell. The scheduler may then determine the path that the sample must take through the workcell, taking into account that there may be multiple paths through the workcell that deliver the same outcome (for example, a workcell may include more than one H&E staining module, which may have different processing capacities). The scheduler must also take into account the information it has received in regard to availability of resources in the workcell, and the status of the workcell modules. Further, the scheduler may take into account the usage of shared resources, for example a coverslipper, and the availability of buffer areas or wait stations for samples that may be held under certain conditions (e.g., humidity) prior to further processing. By using this information, the scheduler may determine which modules are most suitable for which processing steps, and may therefore determine an optimal processing path for a sample or collection of samples.

The optimization of scheduling can be determined according to user defined optimization rules. For example the system may be arranged to minimize turn-around time, by sending sample containers as soon as the next module is free, or may be arranged to minimize reagent use, by waiting until sample containers are full before sending them to the modules.

The scheduler may additionally be able to interface to modules to provide instructions for the processing of samples delivered to the module. A workcell module may provide for multiple staining protocols to be run on samples, for example one protocol may be optimized for thick tissues and another for thinner tissue sections. If a container of thinly cut tissue samples is loaded onto the workcell, the container may be passed to a free processing module, along with instructions from the scheduler to the module to use the protocol appropriate for thinly cut sections.

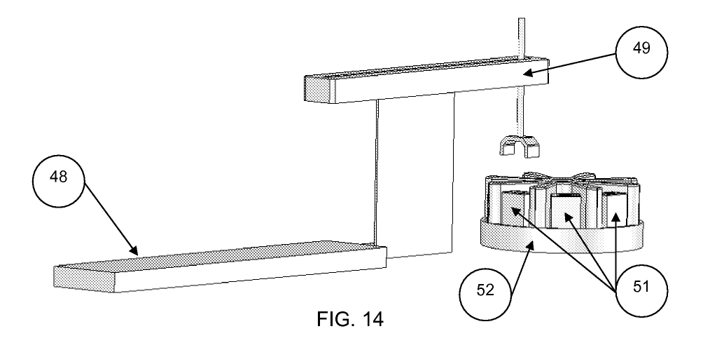

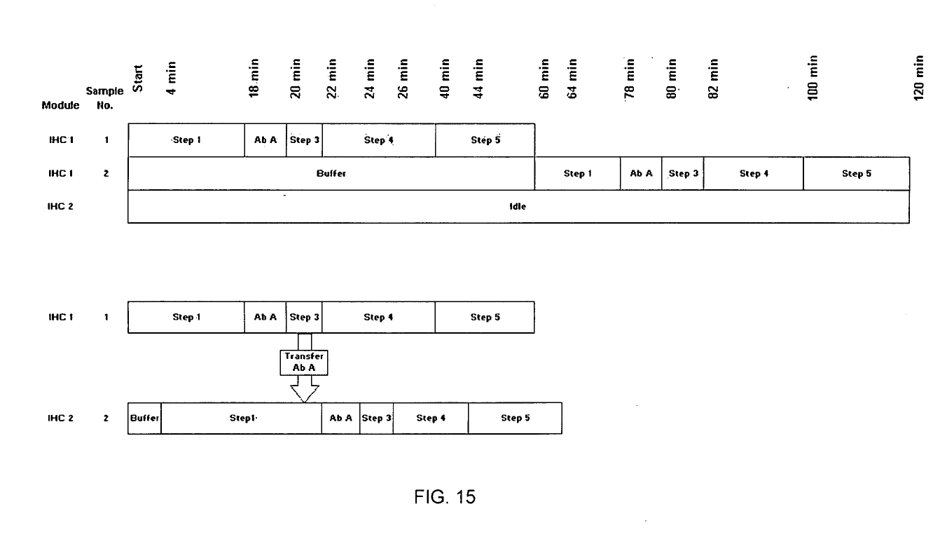

As shown schematically in FIG. 6, the scheduler may interface to one or more sorting modules, 22 and 23, that can move samples between containers. By providing the option of pre-sorting samples into appropriate containers, this may enable the scheduler to further optimize the usage of resources within a workcell and ensure minimum delay in samples being sent through for diagnosis. Further, the scheduler may interface to a reagent management module to track usage of reagents and optimize routing of samples to modules that have the correct reagents on board. Such a reagent management module is shown in FIG. 14 where the rail 48 of a conveyer leads to and from an optionally refrigerated reagent carousel 52 containing reagent containers 51 or reagent carriers comprising one or more reagent containers, which are in turn transferred by transfer robot 49.

The scheduler may also be designed to interface with an image analysis module, and may use the results from the image analysis to automate the scheduling of further tests on tissue samples as required. For example, multiple sections may be taken from a single tissue cassette, and placed onto multiple slides. A single slide may initially be tested within the workcell (for example, an H&E stain may be performed on the slide to enhance the visibility of cellular morphology, or the slide may be imaged prior to staining to capture images of the cellular morphology, using for example phase contrast techniques). The results of the imaging may then be sent through to the image analysis module, which may, for example, use fuzzy classification or other suitable techniques to analyze the cellular morphology and determine the likelihood of the image representing cancer or infectious disease. Depending on the results determined by the image analysis, further testing may be carried out on the tissue and other slides (for example, a panel of IHC stains may be performed), without the requirement for user intervention.

Modules within a workcell may communicate information about their status to the scheduler. This may allow the scheduler to route samples to bypass a unit that is not functioning correctly, such that the complete workcell can continue to operate, albeit with impaired functionality. The status information, and other information such as QA reports, can also be made available remotely via a network connection such that a remote technician can diagnose the status of the workcell, access service logs and if possible effect repairs and upgrades to instrument software from a remote platform.

Sample-processing times for the various processing modules will vary. In order to optimize throughput of the workcell and resolve conflicts relating to the use of shared resources, the scheduler may allow for samples to be parked in buffer areas within processing modules.

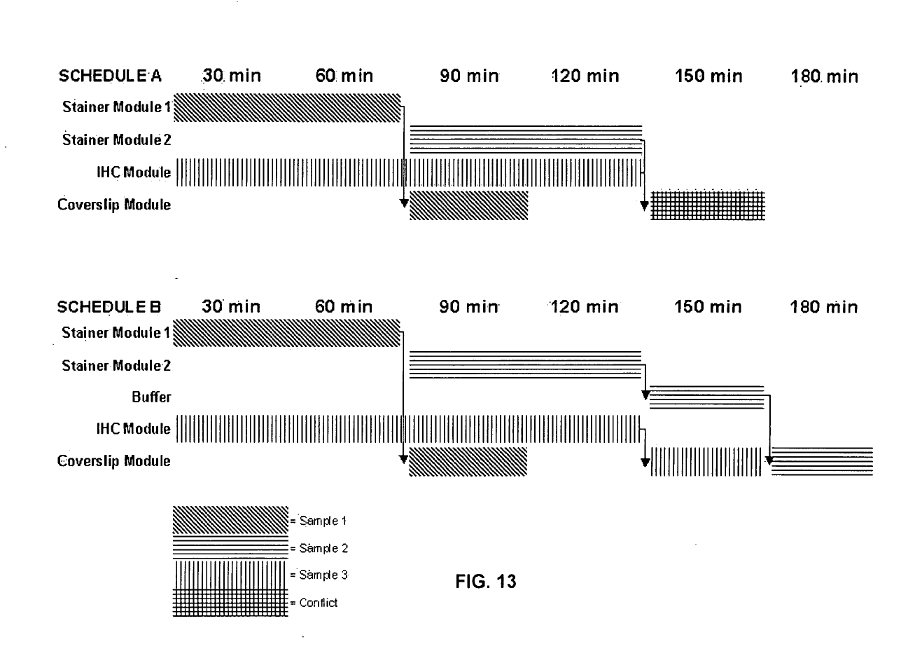

As an illustrative example, FIG. 13 shows a scheduling diagram for a workcell that comprises two staining units, one for H&E where the staining protocol is 30 minutes, and one for IHC where the staining protocol is 60 minutes. If both samples require processing in the cover slipping unit, as shown in FIG. 13 schedule A, then it can be seen that if two H&E batches and one IHC batch are started simultaneously, then a scheduling conflict arises as the output of the second H&E batch will require access to the coverslipping unit at the same time as the output of the first batch from the H&E unit. As shown in FIG. 13 schedule B, the scheduler may resolve this conflict by arranging to park samples from either the H&E stainer or the IHC stainer in the buffer area prior to coverslipping. Selection of which module to park can be carried out on any suitable criteria, for example batch size (e.g., if the IHC unit has a smaller batch size than the H&E unit it may be given a higher priority, as this will free both modules quicker), or may depend on requests for resources (for example, if there are other batches waiting for the H&E stainer and none for the IHC unit, the H&E batch may be given the higher priority).

Workcell

It can be seen that a workcell for processing histology samples can be produced by combining the elements described above. A workcell comprises a conveyor system, a scheduler and one or more processing modules. Samples are passed between modules in carriers in order to effect the desired processing. The workcell is modular, in that it can be built up from modules, and capacity or additional features can be added to the workcell by adding additional modules. The workcell is scalable, in that multiple modules providing a similar function can be added to the workcell to increase capacity. The workcell is configurable, in that the configuration and physical layout of the workcell can be chosen to suit the requirements of a laboratory, and the modules may be connected together in any suitable order. Workcells may operate on a range of sample carriers, such as microscope slides and tissue cassettes.

The combination of modules within a workcell is chosen to meet the needs of a laboratory. A simple workcell for routine processing slides may combine modules providing the functions of bake, H&E stain, and coverslipping. A more complex workcell suitable for a larger laboratory may include a module for sorting, baking, multiple modules for H&E staining, a module for special stains, multiple modules for IHC staining, a module for reagent management, a module for coverslipping, a module for imaging of slides, and a module for sorting of slides for delivery to pathologists.

Sorting

For processing and staining of tissue samples, it is usual to batch samples requiring similar processing into racks, trays, baskets or other forms of container. This may be done by human operators prior to placing the container into the workcell input, for example it may be an activity of the grossing technicians, or microtome operators. However, in order to optimize routing of the samples through the workcell, and to balance the workload of diagnosing pathologists who are receiving samples from the output of the workcell, it is preferable that a module is provided that allows moving of sample carriers from one container to another. In addition, even if samples are batched into containers before entering the input of the workcell, the containers may arrive in any order, and this order may generally not be the best order for the workcell to handle the processing of the samples.

One embodiment of a workcell therefore has at least one input sorter, containing a number of storage bays for sample containers, and possessing the ability to move sample carriers between containers. The sorter interfaces to the scheduler, and can handle the sorting of both sample carriers, and sorting sample containers holding a plurality of carriers. Sorting may comprise two forms—physically transferring objects (sample carriers, sample containers) from one location to another and prioritizing objects or containers of objects. The sorting module may additionally have a queuing area that interfaces to the conveyor, where samples and containers are positioned in order after sorting.

In a simple system, the operator can conduct the physical sorting of samples into relevant containers prior to loading them into the workcell. For example, special racks and trays may be provided that are designated for different staining protocols, e.g., an H&E designated rack, or an IHC designated tray. The operator would load the samples into containers appropriate for the processing that is to be carried out. Each tray or rack would have an identifier that the workcell would read to identify the required processing for the container. The sorting module then communicates the identities of these racks to the scheduler, which prioritizes the removal of the racks from the sorting module according to user-definable criteria including, but not limited to, urgency, staining protocol, processing, and pathologist requesting test.

In a more complex system, the input sort module can be configured so that it can identify individual sample carriers, and reorder the sample carriers within containers, move the sample carriers between containers, and change the order of containers holding sample carriers, as necessary. The sorting modules can include the ability to move sample carriers from one form of container (e.g., rack, tray or basket) to another form of container so as to use a form of handling that is most appropriate to the processing capability of the various modules making up the workcell.

If the conveyor system is designed such that the containers can be returned to the sorting module after completion of the functions of a module, then it may be possible to provide only one sorting module per workcell, which performs the functions of sorting for input and output, and of transferring samples between different types of container as necessary. Alternately, it may be advantageous to provide an output-sorting module, with similar functions to the input-sorting module. This may be arranged to sort the processed samples according to user definable rules, e.g., sorting samples into racks for review by a pathologists based on sample type and workload balancing between pathologists. FIG. 6 shows schematically an example workcell configuration including both input 22 and output 23 sorting modules.

In relation to the sorter 22 or 23, a further embodiment includes an instrument having an interrogator for identifying the samples, after they are loaded into the sorter. Once identified, the samples, for example on microscope slides such as shown in FIG. 16, can be placed in a tray 13. The sorter may have a number of trays 13, and may place all the slides requiring the same test or same type of test, into the same tray for ease of processing. For example, on an IHC instrument such as the Bond-max instrument, a tray may have a number of slides, and each slide may require a different antibody to be applied. However, all slides will have similar timing for exposure of each reagent in the test and can therefore be put on the same tray. Similarly, a rack may be filled with slides requiring the same H&E protocol, wherein the sorter fills the tray or rack before sending it to the appropriate module. If urgent processing is required, the tray or rack may be sent from the sorter before it is full. The sorter may have a wait station associated with it so that the tray or racks can wait for a period of time before they may be sent. A timer may be used to ensure that partially filled trays or racks do not spend too long before being processed.

Reagent Management

The workcell may optionally comprise a separate module for management and storage of some or all of the reagents used within the workcell. This module may provide a refrigerated area, which is used to store containers of temperature-sensitive reagents when not in use. The reagent management module may interface to the scheduler and the conveyor system, and in combination with these systems provides for the ability to transfer containers of reagents between modules requiring them, and the storage area, as necessary. An embodiment of such a reagent management systems is shown schematically in FIG. 14.

The module is designed such that a reagent, reagent container or collection of reagent containers in a carrier may be automatically taken from a storage area, which may be refrigerated, and delivered to a usage area (for example within a staining module), which may not be refrigerated. The reagent is used for a period of time, and then when the reagent is no longer required, it is automatically returned to the refrigeration area where it is stored for later use. Reagent containers may be transferred on the conveyor singly, or in trays. Reagent containers, or reagent trays, may be designed in a similar fashion to sample containers, with locating features that interface to the conveyor, and machine-readable identification. Such an automated, refrigerated reagent management module may enable the workcell to operate unattended, for example for overnight runs. The reagent management may also be plumbed or piped such that a network of fluid transmission paths is arranged to provide reagents (such as bulk reagents) for the staining modules, and to collect the waste from the modules.

The level of reagent within a container may be tracked, for example by liquid level sensing or by tracking the usage of the reagent within the workcell modules. This tracking may be done centrally, for example by the workcell scheduler, or may be tracked on the reagent container itself, for example using a machine-addressable memory device that can be written to whenever the reagent is used. By tracking the reagent usage, the scheduler may interface to the reagent management system to identify the number of slides that may be stained by a particular container of reagent. This information may be used, for example, to direct a reagent container to a staining module that contains sufficient reagent for the number of slides that will be delivered to the module in the next batch. In addition, the reagent usage information may be used to prompt the user to change reagents, and to order fresh reagent as required.

In a preferred embodiment, reagents such as antibodies are of high value, and have a limited shelf life, so it is usual for a laboratory to hold only a limited inventory of reagents. Indeed, for antibodies that are not regularly used in a lab, it is common for the lab to hold an inventory of only one container at any one time of these low-use antibodies. When there are multiple staining units within a workcell, more than one staining module may require access to a particular antibody. It is therefore highly desirable that the reagent management unit is interfaced to the scheduler and conveyor, such that reagents can be moved not only between modules and storage, but also between different modules as required. This is illustrated in the following example.

A particular workcell is configured with two IHC staining modules, each of which has the capacity to process a single tray of up to 10 slides at a time. The first IHC module, module 1, is loaded with a tray of slides, and one of the processing steps for one or more of the slides requires antibody A. Antibody A is only required for one step in the staining protocol, which in this example is scheduled to occur approximately 18 minutes after commencement of the staining protocol, with dispensing of the antibody taking 2 minutes, while the total staining protocol for module 1 takes 60 minutes. The second IHC staining module, module 2, is initially free. A second tray of slides enters the workcell at the same time that module 1 commences its staining protocol. Again, one or more of the slides requires processing using antibody A. FIG. 15 shows this situation schematically.

In the case where only one container of antibody A is available within the workcell, this container would already be in use in module 1. If the reagent containers are not able to move between modules, then the workcell may not configure module 2 properly to stain the second tray of slides, and as shown in FIG. 15 the second module may remain idle. The second tray of slides would have therefore have to be stored until module 1 is free, which may be in excess of 60 minutes, while the second IHC module remains unused. This will artificially limit the capacity of the workcell.

If, however, the workcell is arranged such that reagents can be conveyed between modules within the workcell, the delay in processing the second tray of slides can be minimized. For example, the scheduler can take into account the reagent dispense time (in this example 2 minutes) and reagent transfer time (again, in this example 2 minutes) between modules, which in this case totals 4 minutes, and then arrange for the samples to be conveyed to IHC module 2 4 minutes after the first batch starts on IHC module 1. Processing of step 1 can then commence. After completion of the dispense of antibody A, in module 1, which occurs in this example 20 minutes after module 1 commences staining, the scheduler may request module 1 to pass the container holding antibody A to module 2. The reagent container arrives in place at module 2 in time for the second step of the processing in module 2 requiring antibody A. As can be seen from FIG. 16, by allowing movement of reagents between modules, throughput of the workcell may be optimized, while allowing a minimum of reagent inventory to be held.

A person skilled in the art will recognize that embodiments described herein may be implemented using one or more computers. In that case, the method steps disclosed herein may be embodied as instructions that comprise a computer program. The program may be stored on computer-readable media, such as floppy disks, optical discs (e.g., compact discs), or fixed disks (such as hard drives and the like), and may be resident in memory, such as, for example random access memory (RAM), read-only memory (ROM), firmware, or flash RAM memory. The program as software may then be executed on a computer or microprocessor device to implement the method. The program or portions of its execution, may also be distributed over multiple computers in a network having a topology corresponding to one or a combination of: a small area such as in a LAN (Local Area Network); a large campus or city area such as in a MAN (Metropolitan Area Network) or; a wide geographical area such as in a WAN (Wide Area Network). As an example, the present invention may be suitable for use with a computer network implementation of a quality assurance (QA) or maintenance system for diagnosing faults and servicing modules or instruments to effect service and repairs and upgrades to instrument software from a remote platform or a central controller or micro-controller.

As the present invention may be embodied in several forms without departing from the spirit of the essential characteristics of the invention, it should be understood that the above described embodiments are not to limit the present invention unless otherwise specified, but rather should be construed broadly within the spirit and scope of the present invention as defined in the appended claims. Various modifications and equivalent arrangements are intended to be included within the spirit and scope of the present invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.”

What is claimed is:

1. A method of routing a plurality of tissue samples in a laboratory for sample processing, the method comprising the steps of:
selectively transporting a plurality of tissue samples in at least one tissue sample container to a plurality of sample processing modules where each module is adapted to perform at least one sample processing task;
accommodating the at least one tissue sample container on a conveyor adapted to engage a plurality of configurations of tissue sample containers;
releasably engaging connecting means of the conveyer with corresponding releasable connecting means disposed on each of the configurations of tissue sample containers; and
communicating with at least one of the modules and the tissue sample containers to convey information operatively associated with the sample processing.

2. The method as claimed in claim 1, wherein each of the plurality of configurations of tissue sample containers corresponds to at least one particular tissue sample processing task.

3. The method as claimed in claim 1, wherein the step of selectively transporting comprises at least one of the steps of:
bypassing at least one module; and
temporarily parking tissue samples proximate to at least one of a module and the conveyer.

4. The method as claimed in claim 1, further comprising the step of:
sorting tissue samples to optimize tissue sample processing wherein the step of sorting comprises at least one of:
moving tissue samples from one container to another;
rearranging tissue samples within a container;
performing at least one of the steps of moving and rearranging at the conveyer;
performing at least one of the steps of moving and rearranging at one or more modules;
performing at least one of the steps of moving and rearranging remotely from the conveyer;
performing at least one of the steps of moving and rearranging remotely from the modules; and
processing the information that is operatively associated with the sample processing in accordance with predetermined criteria, wherein the predetermined criteria comprises scheduling information.

5. The method as claimed in claim 1, further comprising the step of:
managing reagents for use in at least one module wherein the step of managing reagents comprises at least one or a combination of:
storing reagents for use over time;
refrigerating reagents;
collecting and disposing of waste reagents from modules;
tracking reagent use;
scheduling reagent use; and
conveying reagents between modules, wherein the step of conveying reagents between modules comprises selectively transporting at least one reagent container on a conveyor adapted to engage one or more of:
reagent containers comprising a plurality of configurations corresponding to at least one particular tissue sample processing task; and
carrying means for carrying a plurality of reagent containers comprising one or more configurations.

6. The method as claimed in claim 5, further comprising the step of scheduling at least one of the method steps wherein the step of scheduling comprises at least one or a combination of the following steps:
prioritizing sample processing tasks;
prioritizing the selective transport of tissue samples;
prioritizing the communication of information operatively associated with sample processing;
prioritizing the step of sorting;
prioritizing the step of managing reagents;
prioritizing the step of conveying reagents; and
tracking tissue samples, wherein the step of tracking tissue samples comprises; determining one or more of the identity of a tissue sample, and the location of a tissue sample; identifying at least one of; a tissue sample, a tissue sample carrier, and a tissue sample container, and, wherein the step of scheduling is performed by a controller at one or more of:
a module;
a point on the conveyer; and
a controller point remote from the conveyer and the modules.

7. The method as claimed in claim 6, further comprising the step of providing the controller with one or a combination of:
information from at least one module corresponding to at least one of capabilities of the module; status of the module; samples that are processed by the module; time required for processing samples; reagents required by and in use by the module; minimum and maximum processing times of a module;
information from the conveyer corresponding to at least one of capabilities of the conveyer; status of the conveyer; tissue samples that are conveyed by the conveyer; instructions for conveying samples; time required to convey samples;
information from a Laboratory Information System (LIS) corresponding to at least one of identity of tissue samples; processing protocols for samples;
status of samples; grouping of samples;
information corresponding to minimum and maximum holding times for samples at buffer locations on the conveyer or at one or more modules;
information corresponding to priority of tissue samples for sample processing;
information applied to or in relation to tissue sample containers or tissue sample carriers;
information corresponding to laboratory cutting rules;
information corresponding to the location of a tissue sample, tissue sample carrier or a tissue sample container;
information relating to the usage and storage of reagents; and
information manually entered by a user.

8. The method as claimed in claim 1, wherein the at least one sample container comprises one or more of:
a rack;
a basket; and
a tray,
and wherein the tissue samples are disposed on sample carriers.

9. The method as claimed in claim 1, wherein the sample carriers comprise one or a combination of:
tissue cassettes; and
microscope slides;

10. The method as claimed in claim 1, wherein the at least one sample processing task comprises one or a combination of:
tissue processing;
embedding;
microtoming;
slide baking;
dewaxing;
epitope retrieval;
sample sorting;
tissue staining;
coverslipping;
image capture;
image analysis;
transferring samples; and
reagent management.

11. A conveyer for selectively transporting a plurality of tissue samples disposed in at least one sample container to a plurality of sample processing modules, each module adapted to perform at least one sample processing task, the conveyer comprising:
a receptacle for accommodating the at least one sample container, the receptacle being adapted to engage a plurality of configurations of sample containers, wherein the receptacle comprises a shuttle and the shuttle comprises a drip tray for collecting waste from a conveyed sample container; and
a plurality of interconnectable segments, said segments comprising a rail and adapted to selectively form, upon interconnection, at least one guide path between modules;
wherein the receptacle is movably attached to the at least one guide path for conveying the at least one sample container to the plurality of sample processing modules and said receptacle comprises releasable connecting means for engaging corresponding releasable connecting means disposed on each of the configurations of tissue sample containers;
an interface for connection to a controller adapted for scheduling movements of the conveyer;
an interrogator for interrogating a data carrier applied on or in relation to a sample container; and
a transposing means for transposing articles from the conveyor to a module wherein the transposing means comprises a robot arm which comprises releasable connecting means for engaging corresponding releasable connecting means disposed on a plurality of configurations of articles comprising one of:
trays;
racks;
sample containers;
reagent containers; and
reagent carriers.

12. The conveyer as claimed in claim 11, wherein data obtained by the interrogator is used by the controller for one or a combination of:
verifying the identity of a sample container; and
determining one or more destinations for the sample container.

13. The conveyer as claimed in claim 11, wherein the at least one guide path between modules extends through horizontal and vertical planes for x-y-z translation of the at least one sample container, the guide path is adapted to bypass one or a combination of modules and the guide path comprises one or a combination of:
a linear configuration;
a loop configuration;
a star configuration; and
a mesh configuration.

14. A tissue sample processing module adapted to perform at least one sample processing task comprising:
a plurality of bays segregated into at least input, output and processing bays; wherein the input bays comprise STAT entry for priority processing and at least one of the input bays and the output bays comprise a holding area for temporarily holding articles, wherein the holding area comprises one of a buffer area for holding samples under predefined conditions around the time of processing, and a queuing area for positioning samples or containers around the time of a sorting procedure; and wherein the bays are adapted for receiving articles comprising at least one of a tissue sample carrier, a tissue sample container, and a reagent container;
at least one refrigerated storage bay for storing one or a combination of at least one reagent container, and at least one reagent carrier comprising a plurality of reagent containers;
transposing means for transposing articles from one bay to another;
an interface between the bays and a conveyer for selectively transporting a plurality of articles disposed in at least one container to at least one further sample processing module;
communication means for communicating information operatively associated with sample processing; and
fluid transmission paths for providing one or a combination of a reagent supply to at least one module, and a waste collection means for collecting waste reagents.

15. The module as claimed in claim 14, further comprising at least one interrogator for reading machine-readable data disposed on one or a combination of:
a tissue sample carrier;
a tissue sample container;
a reagent container; and
a reagent carrier comprising at least one reagent containers.

16. The module as claimed in claim 14, wherein the transposing means comprises a robot arm adapted to move articles from bays to a conveyer wherein the robot arm comprises releasable connecting means for engaging corresponding releasable connecting means disposed on a plurality of configurations of articles comprising one of:
trays;
racks;
sample containers;
reagent containers; and
reagent carriers.

17. The module as claimed in claim 14, wherein the communication means is adapted to communicate with a controller for scheduling sample processing tasks and comprises an interrogator for interrogating one of:
RFID tags;
bar code labels; and
OCR.

18. A first module for tissue sample processing adapted for operative association with a second module by a conveyer for selectively accommodating and transporting at least one tissue sample container between the first and second module where the conveyor is adapted to engage a plurality of configurations of tissue sample containers and wherein each of the plurality of configurations of tissue sample containers corresponds to at least one particular tissue sample processing task.

19. A workcell for tissue sample processing comprising:
a plurality of sample processing modules, each module adapted to perform at least one sample processing task;
transport means for selectively transporting a plurality of tissue samples in at least one of a plurality of configurations of tissue sample containers to the plurality of sample processing modules, wherein each of the plurality of configurations of tissue sample containers corresponds to at least one particular tissue sample processing task and wherein the transport means comprises at least one diverter for bypassing at least one module and temporary parking areas for parking tissue samples for optimizing throughput of samples for sample processing tasks;
communication means for communicating with at least one of the modules and the tissue sample containers to convey information operatively associated with the sample processing; and
a sorting module for sorting tissue samples to optimize tissue sample processing wherein the sorting module comprises means for processing the information operatively associated with the sample processing in accordance with predetermined criteria comprising scheduling information and the sorting module is adapted to perform at least one of:
moving tissue samples from one container to another;
rearranging tissue samples within a container;
moving or rearranging at the conveyer;
moving or rearranging at one or more modules;
moving or rearranging remotely from the conveyer; and
moving or rearranging remotely from the modules.

20. The workcell as claimed in claim 19, further comprising a reagent module for managing reagents for use in at least one module wherein the reagent module comprises at least one or a combination of:
means for storing reagents for use over time;
means for refrigerating reagents;
means for tracking reagent use;
means for scheduling reagent use;
means for collecting and disposing of waste reagents from modules, and;
means for conveying reagents between modules where the means for conveying reagents between modules comprises transport means for selectively transporting at least one reagent container on a conveyor adapted to engage one or more of reagent containers comprising one or more configurations, and carrying means for carrying a plurality of reagent containers comprising one or more configurations, wherein each of the plurality of configurations of reagent containers corresponds to at least one particular tissue sample processing task.

21. The workcell as claimed in claim 19, further comprising scheduling means for scheduling at least one processing task wherein the scheduling means comprises:
a controller positioned at one or more of a module, a point on the conveyer and, a controller point remote from the conveyer and the modules, wherein the controller is adapted to receive and process one or a combination of; information from at least one module corresponding to at least one of capabilities of the module, status of the module, samples that are processed by the module, time required for processing samples, reagents required by and in use by the module, minimum and maximum processing times of a module; information from the conveyer corresponding to at least one of capabilities of the conveyer, status of the conveyer, tissue samples that are conveyed by the conveyer, instructions for conveying samples, time required to convey samples; information from a Laboratory Information System (LIS) corresponding to at least one of identity of tissue samples, processing protocols for samples, status of samples, grouping of samples; information corresponding to minimum and maximum holding times for samples at buffer locations; information corresponding to priority of tissue samples for sample processing; information applied to or in relation to tissue sample containers or tissue sample carriers; information corresponding to laboratory cutting rules; information corresponding to the location of a tissue sample, tissue sample carrier or, a tissue sample container; information manually entered by a user;
tracking means for tracking tissue samples, wherein the tracking means is adapted for determining one or more of; the identity of a tissue sample, the location of a tissue sample and wherein the tracking means is further adapted for identifying at least one of; a tissue sample, a tissue sample carrier, and a tissue sample container;
and wherein the scheduling means is adapted for at least one of the following; prioritizing sample processing tasks, prioritizing the selective transport of tissue samples, prioritizing the communication of information operatively associated with sample processing, prioritizing sorting, prioritizing managing reagents, prioritizing conveying reagents.

22. The workcell as claimed in claim 19, wherein the at least one sample container comprises one or more of:
a rack;
a basket; and
a tray.

23. The workcell as claimed in claim 19 wherein the tissue samples are disposed on sample carriers.

24. The workcell as claimed in claim 19, wherein the sample carriers comprise one or more of:
tissue cassettes; and
microscope slides;

25. The workcell as claimed in claim 19, wherein the at least one sample processing task comprises one or more of:
tissue processing;
embedding;
microtoming;
slide baking;
eewaxing;
epitope retrieval;
sample sorting;
tissue staining;
coverslipping;
image capture;
image analysis;
transferring samples; and
reagent management.
